(19) United States
(12) Patent Application Publication
(10) Pub. No.: US 2018/0140072 A1
(43) Pub. Date: May 24, 2018

(54) Cosmetic Applicator

(71) Applicant: Capicolor International Cosmetics Ltd., Taichung (TW)

(72) Inventor: Ching-Ying Chen, Taichung (TW)

(21) Appl. No.: 15/359,780

(22) Filed: Nov. 23, 2016

(51) Int. Cl. A45D 34/04; B43K 23/08; B43K 8/06

(52) U.S. Cl. CPC A45D 34/04; A45D 2200/1072; B43K 8/06; B43K 23/08

(57) ABSTRACT

A cosmetic applicator includes a tube member, a tubular seat, and a head unit. The tube member has a first end portion having a tube end surface, and a seat connector that protrudes from the tube end surface, a second end portion opposite to the first end portion, and a receiving space extending therethrough. The tubular seat is disposed on the first end portion, and has a seat end surface abutting against the tube end surface, and a seat space formed therein, extending through the tubular seat, communicating with the receiving space, and having a connecting portion rotatably engaged with the seat connector. The tubular seat is rotatable relative to the first end portion between straight and bent positions.

### FIELD

The disclosure relates to an applicator, and more particularly to a cosmetic applicator.

### BACKGROUND

Referring to FIG. 1, a conventional cosmetic applicator 9 (such as an eyeliner or an eyebrow pencil) includes a straight tube member 91, and a head member 92 disposed at an end portion of the tube member 91.

The tube member 91 and the head member 92 extend in a same direction. Referring to FIG. 2, when using the conventional cosmetic applicator 9, a user needs to hold the tube member 91 manually with his/her palm being turned toward his/her face, so as to orient the head member 92 toward his/her face.

However, the abovementioned way of holding the conventional cosmetic applicator 9 is not ergonomic to the user. During the process of applying makeup, the user needs additional effort to stabilize the hand and prevent the hand from trembling, thereby causing difficulty in use.

### SUMMARY

Therefore, an object of the disclosure is to provide a cosmetic applicator that can alleviate at least one of the drawbacks associated with the abovementioned prior art.

Accordingly, the cosmetic applicator includes a tube member surrounding a tube axis, a tubular seat surrounding a seat axis, and a head unit. The tube member has a first end portion, a second end portion, and a receiving space. The first end portion has a tube end surface not perpendicular to the tube axis and defining a first angle with the tube axis, and a seat connector protruding from the tube end surface. The second end portion is opposite to the first end portion along the tube axis. The receiving space extends along the tube axis through the first end portion and the second end portion. The tubular seat is disposed on the first end portion of the tube member, and has a seat end surface abutting against the tube end surface, and a seat space formed therein. The seat space extends along the seat axis through the tubular seat, communicates with the receiving space, and has a connecting portion rotatably engaged with the seat connector of the first end portion of the tube member, such that the tubular seat is rotatable relative to the first end portion between a straight position, where the seat axis is parallel to the tube axis, and a bent position, where the seat axis and the tube axis define a second angle therebetween. The head unit includes a head member that is inserted into the seat space of the tubular seat.

### BRIEF DESCRIPTION OF THE DRAWINGS

Other features and advantages of the disclosure will become apparent in the following detailed description of the embodiment with reference to the accompanying drawings, of which:

FIG. 1 is a perspective view of a conventional cosmetic applicator;

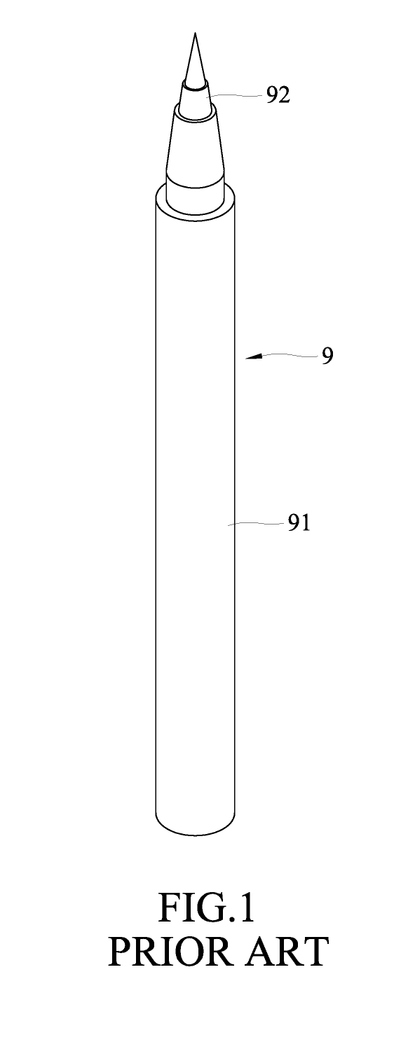

FIG. 2 is a schematic view illustrating the conventional cosmetic applicator being used by a user;

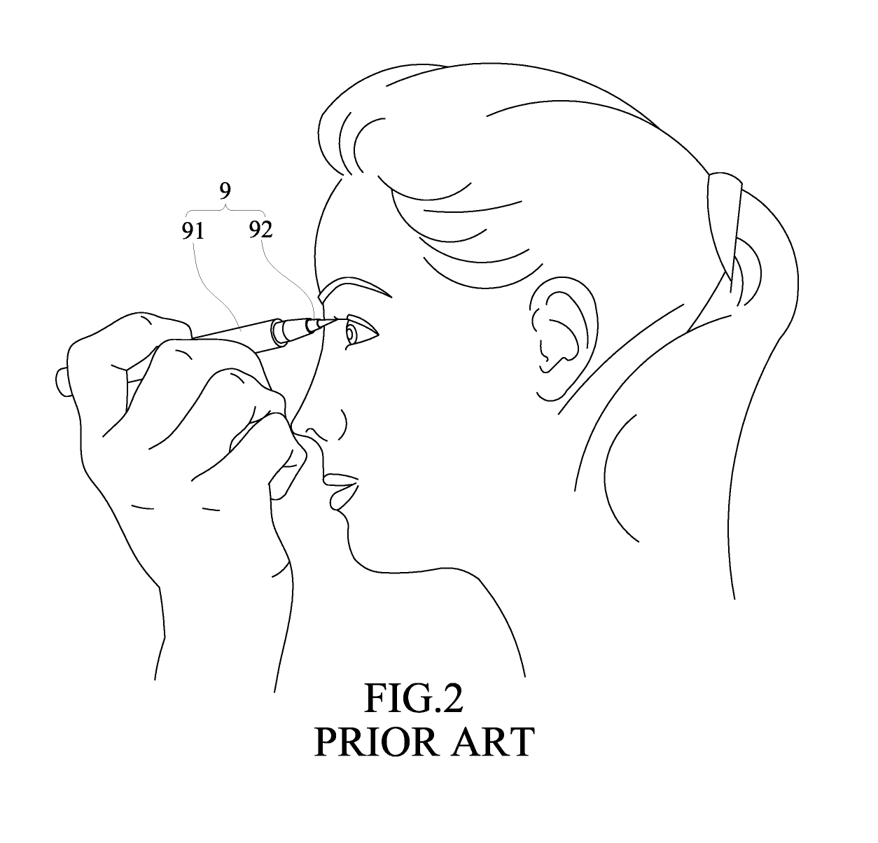

FIG. 3 is a sectional view of an embodiment of a cosmetic applicator according to the disclosure;

FIG. 4 is an exploded sectional view of the embodiment;

FIG. 5 is a sectional view of the embodiment taken along line V-V in FIG. 3;

FIG. 6 is a partly exploded sectional view of the embodiment, illustrating a cap being removed from a tubular seat, and the tubular seat being in a straight position;

FIG. 7 is a fragmentary sectional view of the embodiment, illustrating the tubular seat in a bent position; and

FIG. 8 is a schematic view illustrating the cosmetic applicator of the disclosure being used.

### DETAILED DESCRIPTION

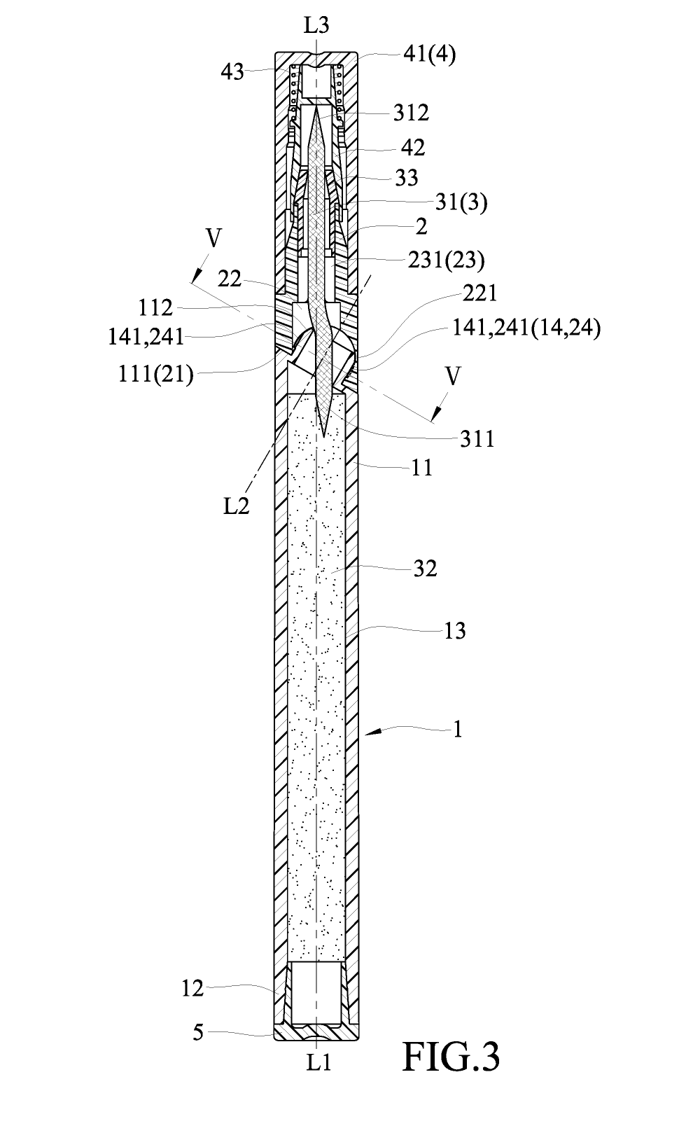

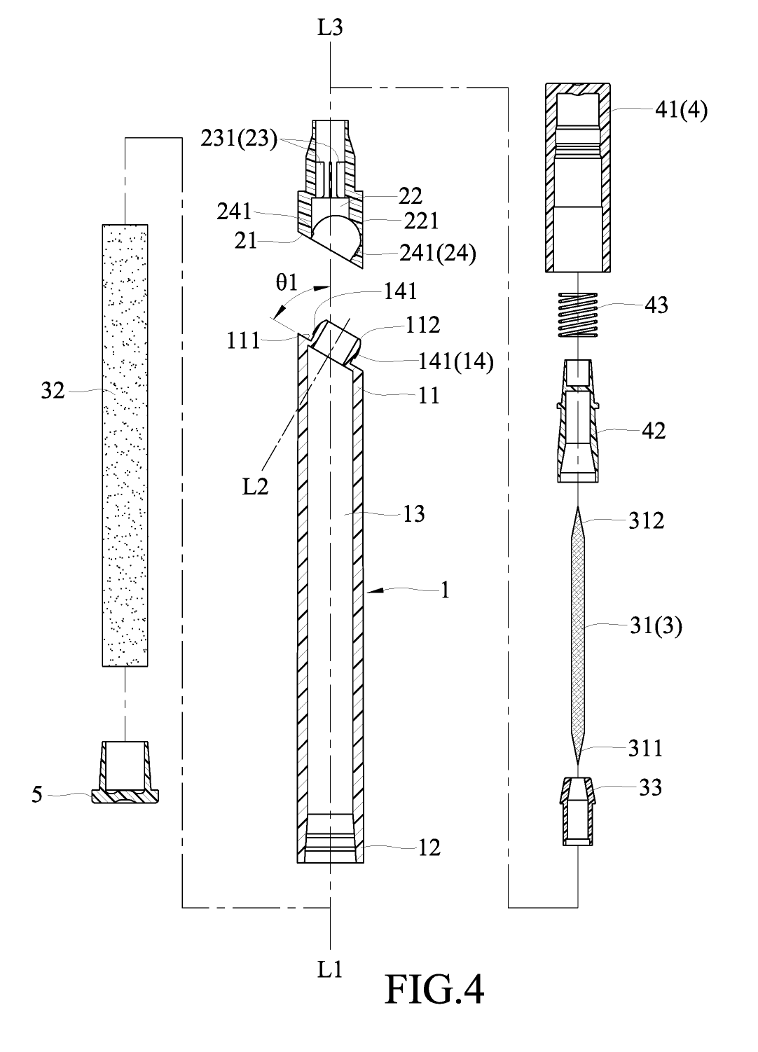

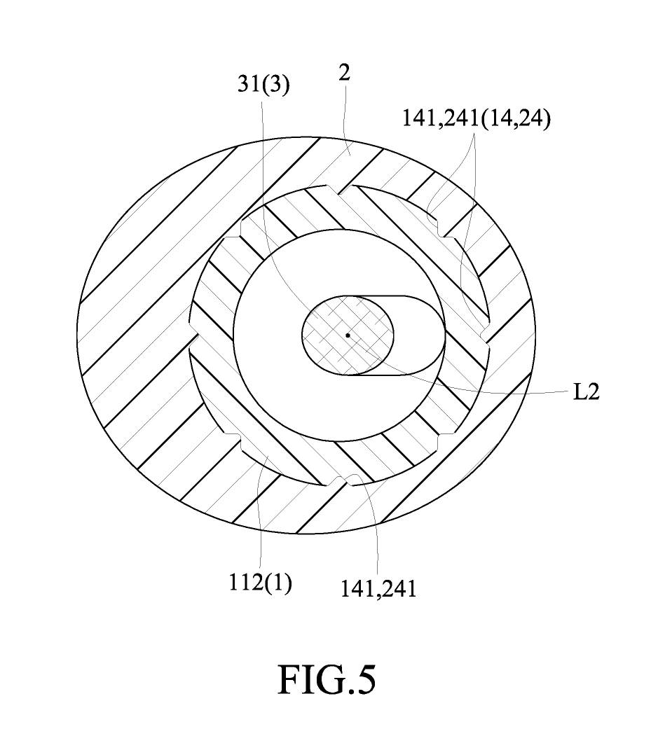

Referring to FIGS. 3, 4 and 5, an embodiment of a cosmetic applicator according to the present disclosure includes a tube member 1, a tubular seat 2, a head unit 3, a cap 4, and a plug member 5.

The tube member 1 surrounds a tube axis (L₁), and has a first end portion 11, a second end portion 12, a receiving space 13, and a first positioning structure 14. The first end portion 11 has a tube end surface 111 not perpendicular to the tube axis (L₁) and defining a first angle (θ₁) with the tube axis (L₁), and a seat connector 112 protruding from the tube end surface 111 and having a connecting axis (L₂). The second end portion 12 is opposite to the first end portion 11 along the tube axis (L₁). The receiving space 13 extends along the tube axis (L₁) through the first end portion 11 and the second end portion 12. The first positioning structure 14 is formed on an outer surface of the seat connector 112, and has a plurality of angularly spaced-apart grooves 141 surrounding the connecting axis (L₂).

In this embodiment, the first angle (θ₁) is 60 degrees, the connecting axis (L₂) is perpendicular to the tube end surface 111, and the seat connector 112 is substantially a spherical frustum.

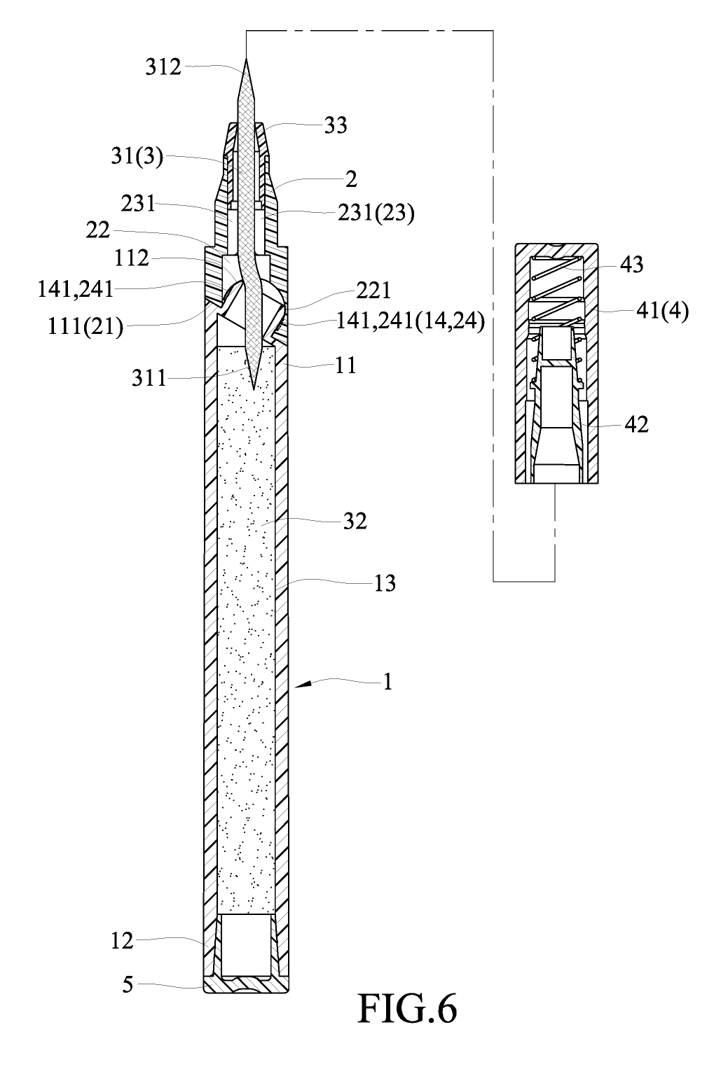

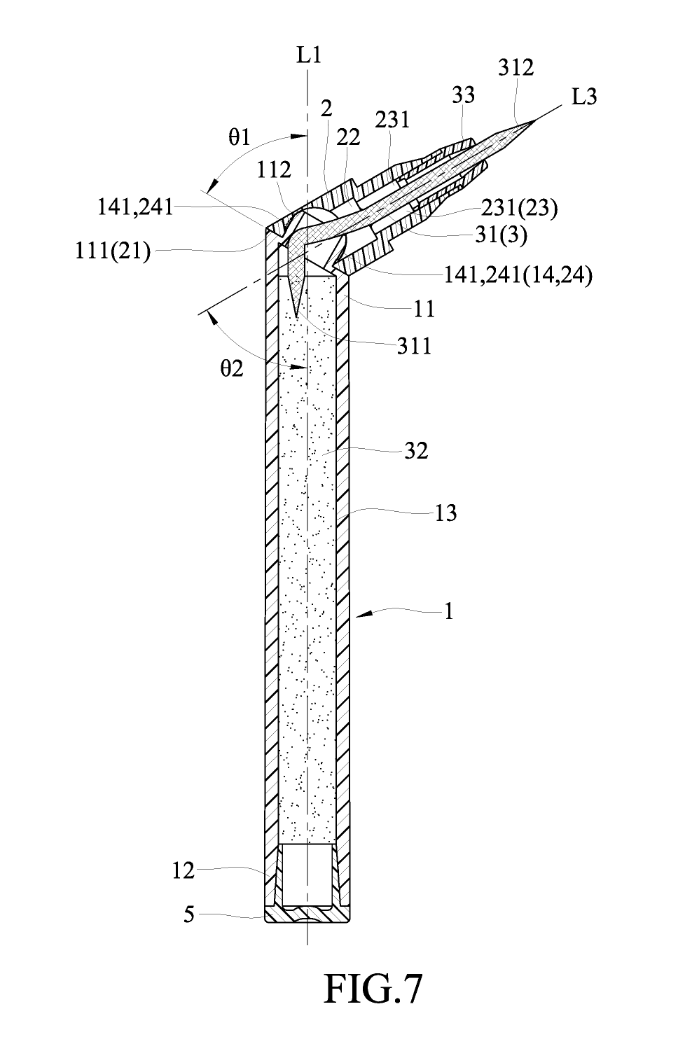

The tubular seat 2 surrounds a seat axis (L₃), and is disposed on the first end portion 11 of the tube member 1. The tubular seat 2 has a seat end surface 21, a seat space 22 formed therein, a securing structure 23, and a second positioning structure 24. The seat end surface 21 abuts against the tube end surface 111. The tubular seat 2 further has an inner surface defining the seat space 22. The seat space 22 extends along the seat axis (L₃) through the tubular seat 2, communicates with the receiving space 13, and has a connecting portion 221 rotatably engaged with the seat connector 112 of the first end portion 11 of the tube member 1, such that the tubular seat 2 is rotatable relative to the first end portion 11 between a straight position (see FIG. 6), where the seat axis (L₃) is parallel to the tube axis (L₁), and a bent position (see FIG. 7), where the seat axis (L₃) and the tube axis (L₁) define a second angle (θ₂) therebetween. In this embodiment, the seat axis (L₃) is collinear with the tube axis (L₁) when the tubular seat 2 is in the straight position, and the tubular seat 2 is configured such that a relationship of θ₂=2×(90−θ₁) is satisfied. Since the first angle (θ₁) is 60 degrees, the second angle (θ₂) is accordingly 60 degrees.

The securing structure 23 is formed on the inner surface of the tubular seat 2, and has a plurality of angularly spaced-apart securing ribs 231. The second positioning structure 24 is formed on the inner surface of the tubular seat 2, and is rotatably engaged with the first positioning structure 14 for positioning the tubular seat 2 relative to the tube member 1 at a desired orientation between the straight position and the bent position. Specifically, the second positioning structure 24 has a plurality of protrusions 241 respectively and removably engaging the grooves 141 of the first positioning structure 14.

The head unit 3 includes a head member 31, a cartridge 32, and a head fixing member 33. In this embodiment, the head member 31 extends through the seat space 22 of the tubular seat 2, and is secured in the securing structure 23. Specifically, the securing ribs 231 of the securing structure 23 grip the head member 31. The cartridge 32 is disposed in the receiving space 13 of the tube member 1. The head fixing member 33 is connected to a front end of the tubular seat 2 which is opposite to the seat end surface 21, is sleeved on the head member 31, and cooperates with the securing structure 23 for fixing the head member 31. The head member 31 has an absorbing end portion 311 inserted into the receiving space 13 of the tube member 1 and connected to the cartridge 32, and an outflow end portion 312 opposite to the absorbing end portion 311 and extending outwardly of a front end of the head fixing member 33. In this embodiment, the head member 31 is made of cotton and is flexible, but in other embodiments, the head member 31 maybe made of other materials that can absorb liquid cosmetics inside the cartridge 32.

Referring further to FIG. 6, the cap 4 is removably coupled to the tubular seat 2 for covering a part of the head member 31 which is outside of the tubular seat 2, (i.e. the outflow end portion 312 of the head member 31). The cap 4 includes an outer cap member 41 coupled removably to the tubular seat 2, an inner cap member 42 disposed in the outer cap member 41, and a resilient member 43 connected between the outer cap member 41 and the inner cap member 42 for biasing the inner cap member 42 to cover tightly the tubular seat 2 when the outer cap member 41 is coupled to the tubular seat 2.

The plug member 5 is inserted into the second end portion 12 of the tube member 1 for closing the second end portion 12.

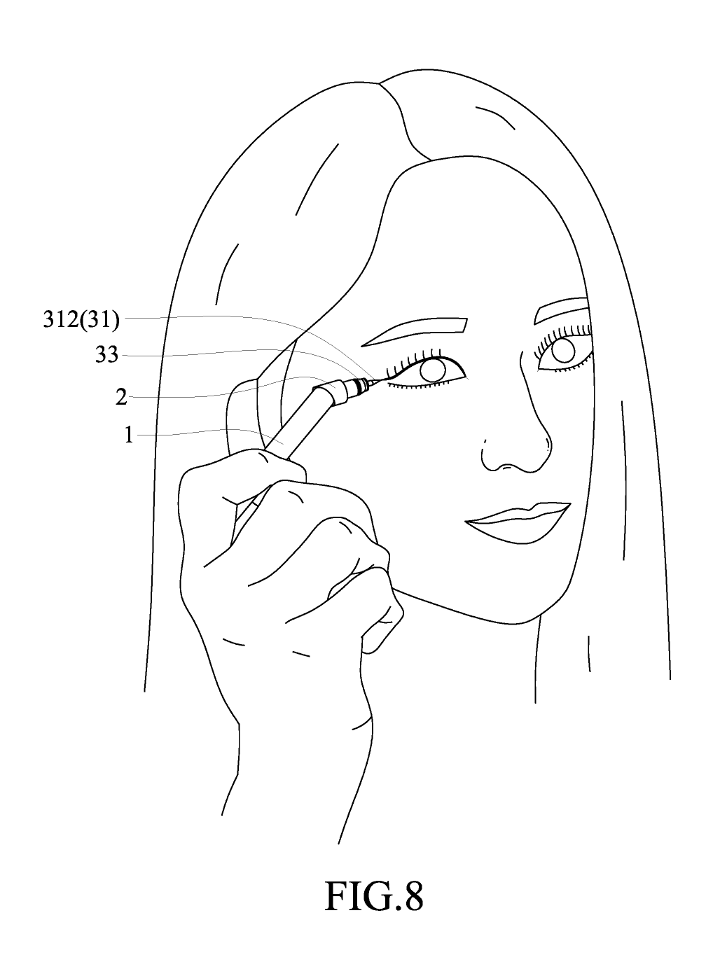

Referring to FIGS. 6 and 7, when the cosmetic applicator of the present disclosure is in use, a user can rotate the tubular seat 2 relative to the tube member 1 to the bent position, and remove the cap 4 from the tubular seat 2 to expose the outflow end portion 312. Referring further to FIG. 8, the liquid cosmetics inside the cartridge 32 flows from the absorbing end portion 311 of the head member 31 to the outflow end portion 312 and finally onto an eyelid of the user. Meanwhile, the configuration of the tubular seat 2 and the tube member 1 can maintain the tube member 1 to be oblique so that the user can conveniently grip the tube member 1. After use, the user can cover the cap 4 on the tubular seat 2 (see FIG. 3) for preventing the head member 31 from being dried upon exposure to air and from accumulating dust on the head member 31. The user can then rotate the tubular seat 2 back to the straight position, where the cosmetic applicator can be conveniently stored. It should be noted that, with the engagement between the first and second positioning structures 14, 24, the tubular seat 2 can be positioned relative to the tube member 1 in multiple other positions between the straight and bent positions.

In summary, in comparison with the conventional cosmetic applicator, the tube member 1 of the cosmetic applicator of the present disclosure can be held by the user in a more ergonomic way, thus undesirable tremble of the user's hand can be avoided during makeup process.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that his disclosure is not limited to the disclosed embodiment but is intended to cover various arrangements included within the spirit and scope of the broadest interpretation so as to encompass all such modifications and equivalent arrangements.

What is claimed is:

1. A cosmetic applicator comprising:
a tube member surrounding a tube axis and having
a first end portion that has a tube end surface not perpendicular to the tube axis and defining a first angle with the tube axis, and a seat connector protruding from said tube end surface,
a second end portion that is opposite to said first end portion along the tube axis, and
a receiving space that extends along the tube axis through said first end portion and said second end portion;
a tubular seat surrounding a seat axis, disposed on said first end portion of said tube member, and having
a seat end surface that abuts against said tube end surface, and
a seat space that is formed therein, that extends along the seat axis through said tubular seat, that communicates with said receiving space, and that has a connecting portion rotatably engaged with said seat connector of said first end portion of said tube member, such that said tubular seat is rotatable relative to said first end portion between a straight position, where the seat axis is parallel to the tube axis, and a bent position, where the seat axis and the tube axis define a second angle therebetween; and
a head unit including a head member that is inserted into said seat space of said tubular seat.

2. The cosmetic applicator as claimed in claim 1, wherein a relationship of θ₂=2×(90−θ₁) is satisfied, where θ₁ represents the first angle, and where θ₂ represents the second angle.

3. The cosmetic applicator as claimed in claim 1, wherein:
said tube member further has a first positioning structure formed on an outer surface of said seat connector; and
said tubular seat further has an inner surface defining said seat space, and a second positioning structure formed on said inner surface and rotatably engaged with said first positioning structure for positioning said tubular seat relative to said tube member at a desired orientation between the straight and bent positions.

4. The cosmetic applicator as claimed in claim 3, wherein:
said seat connector has a connecting axis perpendicular to said tube end surface;
said first positioning structure has a plurality of angularly spaced-apart grooves surrounding the connecting axis; and
said second positioning structure has a plurality of protrusions respectively and removably engaging said grooves.

5. The cosmetic applicator as claimed in claim 1, wherein said tubular seat further has an inner surface defining said seat space, and a securing structure formed on said inner surface and securing said head member therein.

6. The cosmetic applicator as claimed in claim 5, wherein said securing structure has a plurality of angularly spaced-apart securing ribs gripping said head member.

7. The cosmetic applicator as claimed in claim 1, wherein:
said head unit further includes a cartridge disposed in said receiving space of said tube member; and
said head member has an absorbing end portion connected to said cartridge, and an outflow end portion opposite to said absorbing end portion.

8. The cosmetic applicator as claimed in claim 7 further comprising a plug member inserted into said second end portion of said tube member for closing said second end portion.

9. The cosmetic applicator as claimed in claim 1, further comprising a cap that is removably coupled to said tubular seat for covering a part of said head member which is disposed outside of said tubular seat.

10. The cosmetic applicator as claimed in claim 9, wherein said cap includes:
an outer cap member coupled removably to said tubular seat;
an inner cap member disposed in said outer cap member; and
a resilient member connected between said outer cap member and said inner cap member for biasing said inner cap member to cover tightly said tubular seat.
